(19) United States
(12) Patent Application Publication
(10) Pub. No.: US 2023/0086015 A1
(43) Pub. Date: Mar. 23, 2023

(54) IC CARD ASYMMETRIC LABELLING SYSTEM AND IC CARD BUILT-IN PASSWORD INPUT SYSTEM

(71) Applicant: SHANGHAI FINANASIA INC., Shanghai (CN)

(72) Inventor: Shaw Dong XIAO, Shanghai (CN)

(21) Appl. No.: 17/994,133

(22) Filed: Nov. 25, 2022

Related U.S. Application Data
(63) Continuation-in-part of application No. 16/477,941, filed on Jul. 15, 2019, now abandoned.

(30) Foreign Application Priority Data
Jan. 16, 2017 (CN) 201710028208.8

(51) Int. Cl. G06Q 20/34; G06Q 20/40

(52) U.S. Cl. CPC G06Q 20/341; G06Q 20/357; G06Q 20/4014

(57) ABSTRACT

Disclosed are an IC card asymmetric labelling system, an IC card built-in password input system and an IC card built-in password input method. The IC card asymmetric labelling system includes: an IC card, a payment terminal and a cloud end sever. The IC card includes a crypto-key unit and a communication module. The crypto-key unit stores a first private key which is used to sign a message transmitted from the IC card. The communication module establishes a communication connection with a cloud end through the payment terminal, or directly establishes a communication connection with the cloud end. The cloud end stores an open ID of the IC card and associated user information. The open ID is a hash value of a first public key of the IC card and is open to the public.

### CROSS-REFERENCE TO RELATED APPLICATIONS

This application is a continuation-in-part of U.S. application Ser. No. 16/477,941, filed on Jul. 15, 2019, which is the National Stage of International Application No. PCT/CN2018/071914, filed on Jan. 9, 2018, which claims priority to Chinese Patent Application No. 201710028208.8, filed on Jan. 16, 2017, the contents of which are hereby incorporated by reference.

### TECHNICAL FIELD

The present disclosure relates to the field of security of financial card payment, in particular to an IC card asymmetric labelling system and an IC card built-in password input system.

### BACKGROUND

An IC card (Integrated Circuit Card), also known as a smart card, an intelligent card, a NFC card (a card using the technology of Near Field Communication), a microchip card or the like, has a microelectronic chip embedded in a card base, which can provide multiple functions. Due to advantages of high information security, good portability and well developed standardization, IC cards have been widely used in various fields, such as identity authentication, bank payment, public transportation, and access control management.

Although an IC card cannot be cloned by an identity theft as cloning a magnetic stripe card, the improper card labelling system used by banks or credit card companies allows an identity theft to wirelessly “extract” or steal important personal information, such as a name, a birth date, a bank account number, a credit card account number and a three-digit CVV code by placing a mobile POS machine or a NFC-abled mobile phone installed with a malicious APP close to an IC card placed in a pocket of a jacket or a backpack.

The present disclosure provides a card asymmetric labelling system, by which an ID of a physical card and personal information are processed in an asymmetric manner. That is, the open ID of the physical card can be open to the public (i.e., can be told to anybody), but the personal information is stored in a cloud end and can only be accessed by the person who holds the physical card.

In recent years, people have higher and higher requirements on privacy protection, while a server may be hacked to leak personal information. In view of this, the present disclosure provides two solutions. In a first solution, user information is encrypted and stored in a cloud end, and a decryption key is stored on the IC card. In a second solution, user information is encrypted and stored in a distributed manner on the card and a decryption key unique to the user is stored in the cloud end.

For the sake of security, when using an IC card for payment, it is usually necessary to input a password. Currently, due to the limitations of software and hardware, it is usually necessary to enter the password on a public payment terminal such as a POS machine, which may cause the following problems:

1. Potential security problem, that is, a malicious merchant or a third party may peek or steal user passwords by modifying the payment terminal with an extra password recording device;

2. Increased transaction time, that is, each time when using an unfamiliar physical payment terminal to input the password, the user has to learn how to use the payment terminal, while transaction can only be performed at the time of inputting the password, which increases the transaction time; and

3. Hygienic problem, that is, the hygienic condition of a payment terminal is a worry because viruses or bacteria can be spread through user fingers, thereby affecting the user experiences.

In the Chinese utility model patent with the application number CN200420014345.4, a bank card with a built-in keyboard is disclosed, in which a keyboard, a memory microchip, a control circuit microchip, an interface and a miniature long-life lithium battery are embedded. The keyboard is connected to the memory microchip, the memory microchip is connected to the interface, the interface is connected to the control circuit microchip, the control circuit microchip is connected to the keyboard and the memory microchip, and the miniature long-life lithium battery is connected to the memory microchip and the control circuit microchip.

It is mentioned in this utility model patent that when using the bank card with a built-in keyboard, a user needs to first use the built-in keyboard of the bank card at home or other secure place to input data such as a password and a withdrawal amount, so that the data is temporarily stored in the card.

After that, the user goes to an ATM and inserts the bank card with the built-in keyboard into the ATM, so that the card automatically transmits the data such as the password and the withdrawal amount to the ATM. Upon completion of the withdrawal operation, the ATM sends a clearing signal to the card, so that the password and other data are cleared from the card.

By contrast, the present disclosure provides a promising security solution which includes: 1) using encrypted wireless communication so that the physical card is not required to be inserted into any slots that may be or may not be maliciously modified; and 2) using an asymmetric card labelling system.

In the Chinese invention patent application with the application number CN201010502426.9, a bank card with input and output functions is disclosed. Similar to the above patent, a storage module is provided in the bank card, which is used for storing the personal security information for the bank card and the personal identification password for the bank card. The payment security is achieved based on verification of the information.

However, the above payment systems are imperfect. According to the disclosure of the above patents, the user can enter the password, and the computing chip on the card can verify whether the password entered by the user is correct. In some cases, a known old password can be changed into a new password. However, how to set the initial password and how to reset the password (when the user reasonably forgets the password) are not involved in the above patents. However, the password setting and resetting functions are the important integral elements for a password security system. It is neither realistic nor secure to realize the password setting and resetting functions only depending on the limited capabilities of input, display and communication of the IC card.

In addition, another great risk lies in the lack of an asymmetric labelling system in the above two patents. Supposing a hacker has spied the password entered by the user, the hacker can use a new card with a built-in keyboard to send the same password as that of the user, thus bypassing the cloud security system. As the present disclosure digitally signs the password and uses an asymmetric labelling system, a hacker has to steal the physical card held by the user to break-in successfully.

### SUMMARY

It is an object of the present disclosure to provide an IC card asymmetric labelling system and a password input system included in an IC card. Higher security can be achieved with the IC card asymmetric labelling system and the password input system included in an IC card.

In order to solve the above technical problem, an IC card asymmetric labelling system is provided according to the present disclosure, which includes:

an IC card; a payment terminal; and a cloud end, where

the IC card includes a crypto-key unit and a communication module,

the crypto-key unit stores a first private key for signing a transaction message to be sent by the IC card,

the communication module establishes a communication connection with the cloud end via the payment terminal, or establishes a direct communication connection with the cloud end, and the communication module is configured to receive or send a message,

the open ID is obtained by performing one or more times of hash calculation on a first public key of the IC card, a pair of first public key and first private key is generated by the crypto-key unit,

the cloud end stores an open ID of the IC card, the open ID is used for obtaining user information associated with the ID card, and where

during a transaction, the open ID is obtained by the payment terminal from the IC card, and is included in a transaction message and sent to the cloud end, the cloud end performs signature authentication based, and process a fund transaction associated with the transaction message based on user information associated with the open ID.

A password input system included in an IC card is further provided according to the present disclosure, which includes: the IC card asymmetric labelling system, where

the IC card is provided with an input module for inputting a first password, a processor module connected with the input module, where the processor module is connected with the communication module,

the communication module of the IC card establishes a communication connection with the cloud end via the payment terminal,

the cloud end is configured to store a third password and a first public key, and where

during a transaction, the IC card signs the first password based on the first private key, and sends a transaction message with the signed first password to the cloud end,

the cloud end performs signature authentication based on the first public key, and performs password authentication based on the first password and the third password after the signature authentication is passed,

if both the signature authentication and the password authentication are passed, the cloud end processes the transaction message, to complete a fund transaction, and

if at least one of the signature authentication and the password authentication is failed, the cloud end does not process the transaction message.

Compared with the conventional technology, the present disclosure aims to solve the above problems of security, convenience and experience at the system level.

First, in the present disclosure, the user, who is very familiar with his or her own device, only needs to enter a password on his or her own IC card, and entering of the password and the transaction can be asynchronously performed (allowing the transaction to be performed within a few minutes after entering the password), so that the payment process can be completed rapidly and conveniently.

Further, since the IC card is customized, problems such as insanitation are avoided and the user experience is improved.

In a preferred embodiment, the input module comprises N touch pads or keys formed as an array on a surface of the IC card, where N is a natural number greater than or equal to 4. It is to be noted that, in the conventional technology, it is proposed to embed a fingerprint recognition module in a bank/credit card for anti-counterfeit authentication. However, the cost of such a module is significantly higher than the password input module of the present disclosure.

In a case that the number of the touch pads is greater than or equal to 4, a password can be formed by a drawing gesture on the touch pads. Therefore, in a preferred embodiment, the step of inputting the first password through the input module of the IC card includes: recognizing, by the input module, an inputted password based on a drawing gesture performed by a figure on the touch pads. In a case that a same touch pad is allowed to be used multiple times in one password, four or more touch pads are sufficient for forming a password with sufficient complexity. Further, in a case of four touch pads, the password is easy to memorize and is convenient to input.

Further, in a preferred embodiment, N is equal to 9. The touch pads or keys form a nine-square grid on the surface of the IC card, which is in accord with existing user habits and fully takes the user experience into consideration, and improves user adaptability.

Further, in a preferred embodiment, the IC card is further provided with a battery for supplying power to the input module and the processor module. In a case that an independent power supply is provided, operation timing of the input module can be more flexible.

Further, in a preferred embodiment, the IC card is further provided with a solar charging panel or a solar charging film for charging the battery. Considering the low power consumption of the input module and the processor module, charging by using solar energy is sufficient for the power requirement and is convenient.

Further, in a preferred embodiment, the crypto-key unit further stores a second private key. A pair of second private key and second public key is generated by the crypto-key unit. The second public key is stored in the cloud end, for encrypting the user information to obtain a ciphertext of the user information. The ciphertext of the user information is stored in the cloud end.

The cloud end processing a fund transaction associated with the transaction message and user information based on the open ID includes:

obtaining, based on the open ID, a ciphertext of user information associated with the open ID;

sending the ciphertext of the user information to an IC card associated with the open ID, to obtain a second private key that is stored in the IC card based on the ciphertext of the user information, and decrypting the ciphertext of the user information to obtain the user information, and returning the user information;

completing the fund transaction based on the user information and the transaction message, and deleting the user information.

In this way, none of the cloud end, the IC card, and the payment terminal stores a plaintext of account information of a user. The plaintext of the account information of the user is obtained only during a transaction and is discarded when the transaction is completed, improving security of user information, such that privacy is guaranteed.

Further, in a preferred embodiment, the crypto-key storage and transmission unit further stores a cloud end public key. The cloud end further stores a cloud end private key, where a pair of cloud end private key and cloud end public key is generated in the cloud end;

the cloud end public key is used at least for encrypting the user information to obtain a chipertext of the user informationt, the ciphertext of the user information is stored in the IC card, where during a transaction, the IC card sends the ciphertext of the user information to the cloud end, and the cloud end decrypts the ciphertext of the user information with the cloud end private key to obtain the user information, the cloud end completes a found transaction based on the user information and the transaction message, and delete the plaintext of the user information.

In this way, during a transaction, the payment terminal, as a relay for transmitting the message sent by the IC card for the transaction cannot obtain the plaintext of user information, improving security and privacy of data.

Further, in a preferred embodiment, the cloud end further stores a hash value of the user information. The hash value of the user information is used for authenticating the user information obtained by decrypting the ciphertext of the user information. In this way, during a transaction, the cloud end may authenticate user information based on a pre-stored hash value of the user information, so as to guarantee accuracy of a transaction object.

Further, in a preferred embodiment, the third password stored by the cloud end is a one-way hash value of the third password. In a case that the one-way hash value of the third password is stored by the cloud end, only one-way hash values of the first password and the third password are compared with each other to authenticate the password, thereby improving security.

Further, in a preferred embodiment, the system further includes an APP deployed on a mobile terminal, where the APP is in communication connection with the cloud end, and the APP is configured to be started only after comparison between an inputted second password and an inputted fourth password is passed, or to be started only when the APP performs an initial password setting step or a password resetting step, where the fourth password is stored in the cloud end and is obtained after the APP sends the second password to the cloud end.

Further, in a preferred embodiment, the APP, with support of the cloud end, performs the initial password setting step in following ways:

i) obtaining an open ID of the IC card, and authenticating whether the IC card is not used based on the open ID of the IC card; in a case that the IC card is used, exiting the initial password setting step and jumping to the password resetting step;

ii) obtaining user information, and sending the user information to the cloud end to check duplication of the user information; if there is duplication, exiting the initial password setting step;

iii) obtaining following identity authentication information:

a) a mobile phone number and/or an email address;

b) a reserved background issue;

c) biological authentication information;

iv) obtaining the first password inputted by a user and sending the first password to the cloud end, where the cloud end uses the first password as the third password and stores third password; and

v) obtaining the second password inputted by the user and sending the second password to the cloud end, where the cloud end uses the second password as the fourth password and stores fourth password.

Further, preferably, with the support of the cloud end, the APP resets the first password or the second password in the following manner.

The first password is reset in the following steps:

i): obtaining an open ID of the IC card the first password of which is to be reset, obtaining user information associated with the IC card based on the open ID, and outputting the user information for user authentication; and

ii) performing authentication based on at least one piece of identity authentication information, obtaining the first password inputted by a user after the authentication for the identity authentication information is passed, and sending the first password to the cloud end, where the cloud end uses the first password as a third password and stores the first password.

Further, preferably, with the support of the cloud end, the APP resets the second password in the following manner.

The second password is reset in the following steps:

i) performing authentication based on at least one piece of identity authentication information, and obtaining the second password inputted by the user after the authentication for the identity authentication information is passed; and

ii) sending the second password to the cloud end, where the cloud end uses the second password as a fourth password and stores the second password.

Further, preferably, with the support of the cloud end, the APP modifies the password in the following manner.

The first password is modified in the following steps:

obtaining and authenticating a historical first password inputted by the user;

obtaining, if the authentication is passed, a first candidate first password inputted by the user based on the APP and a second candidate first password inputted by the user based on the IC card;

if the first candidate first password is the same as the second candidate first password, using the first candidate first password or the second candidate first password as an updated first password, and signing the first password by using the first private key; and

sending the signed first password to the cloud end, where the cloud end performs the signature authentication based on the first public key, and updates the third password based on the first password after the signature authentication is passed.

The second password is modified in the following steps:

obtaining and authenticating a historical second password inputted by the user;

if the authentication is passed, obtaining a first candidate second password and a second candidate second password inputted by the user based on the APP;

if the first candidate second password is the same as the second candidate second password, using the first candidate second password or the second candidate second password as an updated second password; and

sending the second password to the cloud end, where the cloud end updates the fourth password based on the second password.

Further, preferably, in the step of sending, by the APP, the second password to the cloud end, and updating, by the cloud end, the stored fourth password based on the second password:

the APP calculates a one-way hash value of the second password and sends the one-way hash value of the second password to the cloud end, and the cloud end updates a one-way hash value of the stored fourth password based on the one-way hash value of the second password.

In this way, the second password is not recorded in the APP, and the second password is not sent in a communication channel between the APP and the cloud end, which effectively reduces the risk of the second password being stolen.

Further, preferably, in the step of comparing, by the cloud end, the first password and the third password, and in the step of sending, by a processor module of the IC card, the first password to the cloud end through a communication module of the IC card, and comparing, by the cloud end, the first password and the third password, the processor module calculates a one-way hash value of the first password, and sends the one-way hash value of the first password to the cloud end, and the cloud end compares the one-way hash value of the first password and the one-way hash of the third password.

In this way, the one-way hash value of the first password calculated by the processor module is sent to the cloud end after passing through a payment terminal. Since only the one-way hash value of the first password is received on the payment terminal, the security can be greatly improved, effectively reducing the risk of stealing the password through a counterfeit or modified payment terminal.

Further, preferably, in a case that the first password modified, if the communication module is a wireless wide area communication module, the communication module sends the modified first password to the cloud end after the modified first password is signed by using the first private key; or if the communication module is a wireless short-distance communication module, the communication module sends the modified first password to the cloud end through the mobile terminal after the modified first password is signed by using the first private key.

In this way, the user can set or modify the password according to the communication function of the communication module of the IC card, which is more convenient and effective.

### BRIEF DESCRIPTION OF THE DRAWINGS

FIG. 1 is a block diagram of an IC card with a password input system according to a fifth embodiment of the present disclosure;

FIG. 2 is a schematic diagram of a front surface of an IC card according to an eleventh embodiment of the present disclosure;

FIG. 3 is a schematic diagram of a front surface of an IC card according to a twelfth embodiment of the present disclosure;

FIG. 4 is a schematic diagram of a side surface of an IC card according to a fourteenth embodiment of the present disclosure; and

FIG. 5 is a schematic diagram of a front surface of an IC card according to a fifteenth embodiment of the present disclosure.

### DETAILED DESCRIPTION OF EMBODIMENTS

### First Embodiment

An IC card asymmetric labelling system is provided according to a first embodiment of the present disclosure, which includes: an IC card, a payment terminal and a cloud end.

The IC card includes a crypto-key unit and a communication module.

The crypto-key unit is configured to store a first private key.

The first private key is used to sign a message of the IC card that is to be sent.

The communication module may establish a communication connection with the cloud end through the payment terminal, or directly establish a communication connection with the cloud end, and the communication module is configured to receive and/or send messages.

The cloud end stores an open ID of the IC card and user information associated with the IC card. The open ID is obtained by performing hash calculation based on the first public key of the IC card.

During transaction, the payment terminal obtains the open ID from the IC card and inserts the open ID into the message and send the message to the cloud end. The cloud end obtains the open ID based on the received message, and obtains the user information associated with the IC card based on the open ID, to process a fund transaction related to the message.

In the embodiment, the first private key and the first public key may be generated by any key generation method. The IC card sign may sign all messages to be sent by using the first private key, so that a message receiver (such as the cloud end) can authenticate that the message is received from the IC card, to ensure that the message including authentication information, for example, a password, is received from a correct IC card during data processing (for example, during fund transaction). The open ID of the IC card may be calculated based on the first private key stored therein by performing hash calculation for one or several number of times, which is not limited in the embodiment. The user information may include user financial information (such as account information of banks or credit cards) and user personal information (such as name, date of birth), and other possible user information for transactions or authentications. The open ID may be set (for example, printed) on a surface of the IC card with which the open ID is associated. Alternatively, in order to compatible with some other payment tools, for example, to allow merchants using old-fashioned POS machines or payment terminals to swipe cards, the open ID may be embedded into the magnetic bar of the IC card. In the embodiment, any user who is to transfer money to a holder of an IC card only needs to know the open ID of the IC card to complete the money transfer at the background of the cloud end. During the transaction, the message may also include a transaction amount and information of a receiver (such as the open ID of the IC card of the receiver), so as to determine the details of the fund transaction.

In the embodiment, the communication module of the IC card may have communication functions of a wide area network (WAN). In this case, the IC card may be directly connected to the cloud end through the communication module. It may be understood that the communication module may also have a short-distance communication function. In this case, the IC needs to establish a connection with the payment terminal through the communication module, so as to establish a connection with the cloud end by using the payment terminal as an intermediate.

Compared with the conventional art, in the embodiment, it is only required to know the open ID the IC card including non-user real name information to achieve fund transfer, which improves the privacy protection of users. In addition, all the messages sent through the IC card are signed by using the first private key stored therein, further ensuring the uniqueness of the source of the message, achieving safer transactions or communications.

### Second Embodiment

An IC card asymmetric labelling system is provided according to a second embodiment of the present disclosure. The second embodiment is improvement of the first embodiment. The main improvement is that in the second embodiment of the present disclosure, the crypto-key unit further stores a second private key. The second private key and a second public key are generated by the unit. The second public key is stored in a cloud end and cannot be accessed outside. The second public key is used for encrypting the user information to obtain user information ciphertext. The user information ciphertext is stored in the cloud end.

The operation of processing a message-associated fund transaction based on the open ID by the cloud end includes: obtaining user information ciphertext associated with the open ID; sending the user information ciphertext to an IC card associated with the open ID, to obtain the second private key stored in the IC card; decrypting the user information ciphertext to obtain and rerun user information; and completing the fund transaction based on the user information and the message, and deleting the user information.

In the embodiment, the user information for the fund transaction is stored in the cloud end in a form of ciphertext. The cloud end can receive user information plaintext returned by the IC card only when the cloud end sends the user information ciphertext to the IC card and the user information is decrypted. In this way, an accurate transaction object can be ensured, thereby further improving privacy security of the user information. It should be understood that, in the embodiment, if the communication module of the IC card has only a short distance communication function, the user information ciphertext may be transmitted by forwarding of a payment terminal.

### Third Embodiment

An IC card asymmetric labelling system is provided according to a third embodiment of the present disclosure. The third embodiment is improvement of the first embodiment or the second embodiment. The main improvement is that in the third embodiment of the present disclosure, the crypto-key unit further stores a cloud end public key. The cloud end further stores a cloud end private key. The cloud end private key and the cloud end public key are generated by the cloud end.

A message to be directly sent to the cloud end from the IC card or to be sent to the cloud end via the payment terminal from the IC card is encrypted with the cloud end public key and then is sent.

The cloud end private key is used to decrypt the received message encrypted with the cloud end public key sent from the IC card.

For example, the cloud end public key is used to encrypt at least the user information to obtain the user information ciphertext. The user information ciphertext is stored in the IC card. During the transaction, the IC card sends the user information ciphertext to the cloud end. The cloud end decrypts the user information ciphertext with the cloud end private key to obtain the user information. The cloud end completes the fund transaction based on the user information and the message, and deletes the user information.

In the embodiment, data sent from the IC card to the cloud end is encrypted with the cloud end public key. Even if the data is forwarded via the payment terminal, the payment terminal cannot obtain the plaintext since the data is already encrypted, thereby ensuring data privacy and security. In addition, the user information is not stored in the cloud end, and is stored in the IC card locally or stored in a distributed manner in the IC card when the user information in encrypted into ciphertext with the cloud end public key.

In some embodiments, the user information ciphertext obtained by encrypting the user information with the second public key may be stored in the cloud end. During the transaction, the cloud end sends the user information ciphertext to the IC card. The IC card decrypts the user information ciphertext with the second private key to obtain user information plaintext, encrypts the user information with the stored cloud end public key, and then sends the encrypted user information directly or indirectly (for example forwarding via the payment terminal) to the cloud end. The cloud end decrypts the user information with the cloud end private key to obtain user information plaintext, thereby completing the fund transaction.

### Fourth Embodiment

The fourth embodiment is improvement of the third embodiment. The main improvement is that in the fourth embodiment of the present disclosure, the cloud end further stores hash values of the user information. The hash values of the user information are used to authenticate the user information obtained by decrypting the user information ciphertext.

In the embodiment, the cloud end further stores the hash values of the user information. During the transaction, the cloud end authenticates whether received user information to be transacted matches the stored hash values of the user information, thereby ensuring that the transaction object is accurate and related data is not tampered.

In the embodiment, the cloud end further stores the hash values of the user information. During the transaction, the cloud end authenticates whether the received user information to be transacted matches the stored hash values of the user information, thereby ensuring the accuracy of the transaction object.

### Fifth Embodiment

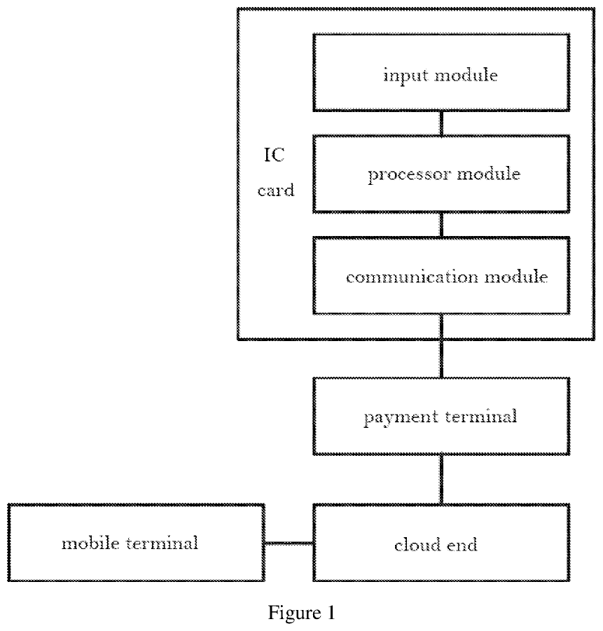

An IC card with a password input system is provided according to a fifth embodiment of the present disclosure. The fifth embodiment is improvement of the first embodiment to the fourth embodiment. The main improvement is that in the fifth embodiment of the present disclosure, the IC card includes the IC card asymmetric labelling system according to any of the first embodiment to the fourth embodiment, as shown in FIG. 1.

The IC card is provided with an input module for inputting a first password and a processor module connected to the input module. The processor module is connected to the communication module.

The communication module of the IC card establishes communication connection with the cloud end via the payment terminal.

The cloud end is further configured to store a third password and the first public key.

During the transaction, the IC card signs the first password based on the first private key, and inserts the signed first password in the message and sends the message to the cloud end.

The cloud end authenticates the signature based on the first public key, and performs password authentication based on the first password and the third password when the signature authentication is successful.

If both the signature authentication and the password authentication are successful, the cloud end processes the message to complete the fund transaction.

If at least one of the signature authentication and the password authentication is unsuccessful, the cloud end does not process the message.

In the embodiment, the third password stored in the cloud end may be a default initial password. In the embodiment, comparing of the first password and the third password may include comparing of password content or password feature values. When the authentication is successful, the payment terminal forwards communication content between the IC card and the cloud end which may be related to the payment, thereby performing the payment by the IC card.

It should be noted that, in the embodiment, the operation of “establishing communication connection with the cloud end by the communication module of the IC card” may be performed before the operation of “inputting the first password to the input module of the IC card, and sending the first password to the cloud end by the communication module of the IC card via the payment terminal”. An order for performing the above operations is not limited herein.

Compared with the conventional art, the present disclosure intends to solve the problem of security, convenience and experience from the system level.

First, according to the present disclosure, a user needs to only input the password on the IC card, and the password inputting may be performed asynchronously with the transaction (the transaction may be performed within several minutes since the password is inputted), thereby quickly completing the payment and realizing better convenience.

In addition, the IC card is customized, and insanitation problem is avoided, thereby improving user experience.

### Sixth Embodiment

An IC card with a password input system is provided according to a sixth embodiment of the present disclosure. The sixth embodiment is improvement of the fifth embodiment. The main improvement is that in the sixth embodiment of the present disclosure, the system further includes an APP arranged in a mobile terminal. The APP performs communication connection with the cloud end.

The APP is opened only when comparing of the second password and the fourth password is successful or when an initial password is inputted to the APP or when password is reset.

The fourth password is stored in the cloud end and is obtained by sending the second password to the cloud end by the APP. For example, the cloud end may use the received second password sent by the APP as the fourth password for storing.

### Seventh Embodiment

An IC card with a password input system is provided according to the seventh embodiment of the present disclosure. The seventh embodiment is a further improvement of the sixth embodiment. The main improvement is that in the seventh embodiment of the present disclosure, the APP, with the support of the cloud end, initializes the password by:

i) obtaining an open ID of the IC card, authenticating whether the IC card is unused based on the open ID of the IC card; otherwise, ending the password initialization step and proceeding to the password resetting step;

ii) obtaining user information, and sending the user information to the cloud end to duplicate check the user information, and ending the password initialization step in a case of duplication;

iii) obtaining the following authentication information:
a) a cell phone number and/or an email address,
b) a preset background question, and
c) biometric authentication information,

iv) obtaining a first password inputted by the user, sending the first password, where the cloud end uses the first password as a third password and stores the first password in the cloud end; and

v) obtaining a second password inputted by the user, sending the second password to the cloud end, where the cloud end uses the second password as a fourth password and stores the second password in the cloud end.

In this embodiment, the authentication based on the cell phone and/or the email address may be considered as authentication performed at the communication layer, for example, may be performed by sending an authentication code or a pop-up confirmation. The authentication based on the preset background question may be considered as authentication performed at the background-quiz layer, for example, displaying a question: “Name of the first pet?”, “Favorite teacher in the elementary school?” or the like. The answer is inputted by the user and compared with the standard answer pre-set by the user. The authentication based on the biometric authentication information may be considered as authentication at the biometric layer, for example, obtaining a fingerprint (in a case that a collector is installed on the mobile terminal) or a face-id (in a case that at least a selfie camera is installed on the mobile terminal) od the user and comparing the obtained fingerprint or face-id with the pre-set biometric information of the user.

It should be understood that when initially setting up a password, the user may be required to preset information for all authentications, for example, pre-set the cell phone number and the email addresses, preset a question and its answer, and pre-collect the biometric information and store the obtained biometric information. In subsequent authentication (for example, in order to change a password or reset a password after forgetting the original password), one or more authentications may be performed as needed.

When setting a password, the user may be asked to input the password several times in succession at the prompt (for example, via the APP, the IC card or other web page) of the system, so as to ensure that the user has correctly inputted the password intended to be set. For example, when setting the first password, the user may be asked to input the first password in the IC card and APP. Only in a case that the first password inputted by the user in the IC card is the same as the first password inputted by the user in the APP, the first password inputted by the user is allowed to be transmitted to the cloud end as the third password. Similarly, when setting the second password, the user may be asked to input the second password in the APP several times in succession. Only in a case that the second password inputted by the user in two consecutive times is the same, the second password inputted by the user is allowed to be transmitted to the cloud end as the fourth password.

### Eighth Embodiment

An IC card with a password input system is provided according to the eighth embodiment of the present disclosure. The eighth embodiment is a further improvement of the seventh embodiment. The main improvement is that in the eighth embodiment of the present disclosure, the APP, with the support of the cloud end, resets the first password or the second password as follows.

The first password is reset by:

i) obtaining an open ID of an IC card the first password of which is to be reset, obtaining user information associated with the IC card based on the open ID, and outputting the user information for user authentication; and

ii) performing authentication based on at least one piece of authentication information, after the authentication information is passed, obtaining a first password inputted by the user, sending the first password to the cloud end, where the cloud end stores the first password as a third password.

In this embodiment, the user may be required to perform one, two or three authentications, and there is no limitation here. When setting the first password after successful authentication, the user may be asked to input the same password at two places (in the IC card and the APP), as in the step of setting the initial first password, before the password inputted by the user is allowed to transmit to the cloud end for storage as the third password. That is, the user successfully resets the first password.

In this embodiment, upon receiving the first password from the APP of the mobile terminal, the cloud end updates the stored third password based on the first password. Those skilled in the art may choose a specific update method based on the existing cryptographic techniques. For example, at its simplest, the original third password may be erased and the content of the first password serves as the new third password. Alternatively, a feature value (for example, a one-way hash value or other relevant value capable of performing checking) of the first password corresponding to the content of the first password is calculated and the is determined as the content of the new third password, and so on.

### Ninth Embodiment

An IC card with a password input system is provided according to the ninth embodiment of the present disclosure. The ninth embodiment is a further improvement of the seventh embodiment or the eighth embodiment. The main improvement is that in the ninth embodiment of the present disclosure, the APP, with the support of the cloud end, resets the second password as follows.

The second password is reset by:

i) performing authentication based on at least one piece of authentication information and, obtaining a second password inputted by the user if the authentication information is passed; and

ii) sending the second password to the cloud end, where the cloud end stores the second password as a fourth password.

In this embodiment, before sending the second password inputted by the user to the cloud, the user is asked to input the second password at least twice in succession and the second password inputted twice in succession is the same before the second password is sent to the cloud.

In the present embodiment, the fourth password is updated based on the second password in a similar manner as the third password is updated based on the first password in the ninth embodiment, which is not repeated here.

### Tenth Embodiment

An IC card with a password input system is provided according to the tenth embodiment of the present disclosure. The tenth embodiment is a further improvement of the eighth embodiment or the ninth embodiment. The main improvement is that in the tenth embodiment of the present disclosure, the APP, with the support of the cloud end, modifies the password as follows.

The first password is modified by:

obtaining and authenticating an original first password inputted by the user;

in a case that the authentication is passed, obtaining a first candidate first password inputted by the user based on the APP, and a second candidate first password inputted based on the IC card;

in a case that the first candidate first password is the same as the second candidate first password, determining the first candidate first password or second candidate first password as the updated first password and signing the updated first password based on the first private key; and

sending the signed first password to the cloud end, where the cloud performs signature authentication by using the first public key and updates the third password based on the first password upon if the signature authentication is passed.

The second password is modified by:

obtaining and authenticating the original second password inputted by the user;

in a case that the authentication is passed, obtaining a first candidate second password inputted by the user based on the APP, and a second candidate second password;

in a case that the first candidate second password is the same as the second candidate second password, determining the first candidate second password or second candidate second password as the updated second password; and

sending the second password to the cloud end, where the cloud end updates the fourth password based on the second password.

In this embodiment, the user is asked to input the first password at least twice in succession (for example, the first candidate first password and second candidate first password) before sending the first password inputted by the user to the cloud end, or input the second password at least twice in succession (for example, the first candidate second password and second candidate second password) before sending the second password inputted by the user to the cloud end. The first password is not sent to the cloud end until the first password inputted twice in succession is identical, or the second password is not sent to the cloud end until the second password inputted twice in succession is identical.

In modification of the first password, in a case that the communication module is a wireless wide-area communication module, the communication module sends the modified first password signed by a first private key to the cloud end. Alternatively, in a case that the communication module is a wireless short-range communication module, the communication module sends the modified first password signed by a first private key to the cloud end via the mobile terminal.

In this embodiment, the communication module may be a module that implements only short-range communication, such as a Bluetooth module or an NFC module. Alternatively, the communication module may be a module that implements only wide-area communication, such as a WIFI module.

In modification of the password, in a case that the communication module is a wireless wide-area communication module, the user is asked to only input the original second password correctly and then the new password (modified first password) can be inputted twice on the IC card. Then, an updated second password is generated based on this password, signed together with timestamp by the first private key, encrypted with the cloud public key, and finally sent to the cloud end via a wide area network without the involvement of the mobile terminal.

In a case that the communication module fails to implement wireless wide area network communication, the communication module first establishes a short-range wireless connection with the mobile terminal and the APP operates to modify the password. As long as the original second password is correctly entered, the APP prompts the user to input a new second password to the IC card, within a specified time period (for example, 2 minutes). The fourth password is then updated based on the new second password. The updated second password and time stamp are signed by the first private key, then encrypted with the cloud public key, and finally sent to the cloud end via a wide area network.

### Eleventh Embodiment

An IC card with a password input system is provided according to the eleventh embodiment of the present disclosure. The eleventh embodiment is a further improvement of the fifth embodiment to the tenth embodiment. The main improvement is that in the eleventh embodiment of the present disclosure, the input module includes N touch pads 1 or N keys forming an array on a surface of the IC card, where N is a natural number greater than or equal to 4.

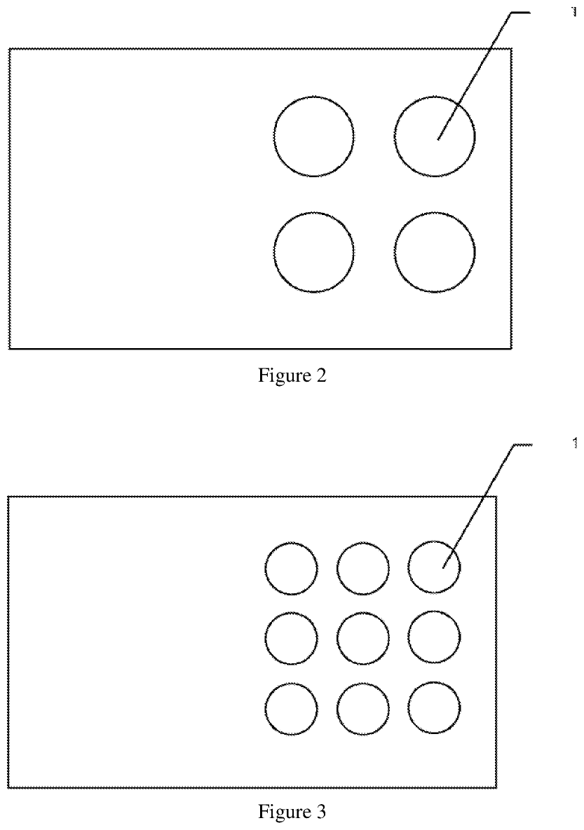

In a case that the number of touch pads 1 is greater than or equal to 4, a password may be obtained by drawing a gesture on the touch pads 1. In the embodiment, as shown in FIG. 2, the number of touch pads 1 is 4. In the step in which the first password is inputted to the input module of the IC card, the input module identifies the inputted password based on the gesture drawn by a finger on the touch pads 1. In a case that it is allowed to use a same touch pad 1 multiple times to obtain a password, a password with sufficient complexity can be obtained with more than or equal to four touch pads 1. In addition, in a case that the number of the touch pads 1 is 4, it is easy to remember and input a correspondingly obtained password.

It is apparent that in the embodiment, the number of the touch pads 1 or the keys is not limited to 4. Considering the cost and versatility, 4 to 12 touch pads 1 or keys are suitable.

It should be noted that it is proposed to embed a fingerprint identification module in a bank card/credit card for anti-counterfeiting authentication according to the conventional technology. However, the cost of the fingerprint identification according to the conventional technology is significantly higher than the cost of the password input module according to the present disclosure.

### Twelfth Embodiment

An IC card with a password input system is provided according to the twelfth embodiment of the present disclosure. The twelfth embodiment is different from the eleventh embodiment. The main difference is that, the number of the touch pads 1 or the keys is 4 in the eleventh embodiment of the present disclosure, and in the twelfth embodiment of the present disclosure as shown in FIG. 3, the number of the touch pads 1 or the keys is 9.

The touch pads 1 or the keys form a nine grid on the surface of the IC card, conforming to the user's habits, fully considering the user's experience, and thereby improving the user's adaptability.

### Thirteenth Embodiment

An IC card with a password input system is provided according to the thirteenth embodiment of the present disclosure. The twelfth embodiment is a further improvement of the fifth embodiment to the twelfth embodiment. The main improvement is that in the thirteenth embodiment of the present disclosure, the IC card is further arranged with a battery for supplying power to the input module and the processor module. With the independent power supply, the use time of the input module can be flexible.

### Fourteenth Embodiment

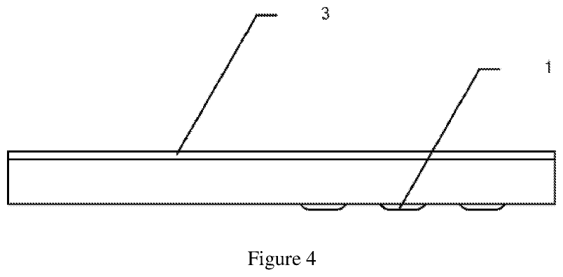

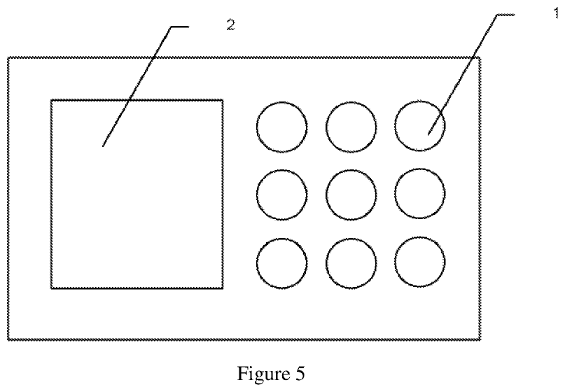

An IC card with a password input system is provided according to the fourteenth embodiment of the present disclosure. The fourteenth embodiment is a further improvement of the fifth embodiment to the thirteenth embodiment. The main improvement is that in the fourteenth embodiment of the present disclosure, as shown in FIG. 4, the IC card is further arranged with a solar charging panel 3 or a solar charging film for charging a battery. Due to the low power consumption of the input module and the processor module, the power is guaranteed with the solar charging manner, facilitating the charging process.

It should be noted that in the embodiment, the solar charging panel 3 or the solar charging film is arranged on a side opposite to the side on which the input module is located. Since the input module occupies a part of a surface area of the IC card and the charging efficiency of the solar charging panel 3 is directly determined by a surface area of the solar charging panel 3, the solar charging panel 3 or the solar charging film may occupy a large area by arranging the solar charging panel 3 or the solar charging film on the side opposite to the side on which the input module is located, thereby achieving a high charging rate.

### Fifteenth Embodiment

An IC card with a password input system is provided according to the fifteenth embodiment of the present disclosure. The fifteenth embodiment is a further improvement of the fourteenth embodiment. The main improvement is that in the fifteenth embodiment of the present disclosure, as shown in FIG. 5, the IC card is further arranged with a display screen 2, and the display screen 2 is connected to the processor module in communication. The display screen 2 is configured to display transaction confirmation information from a payment device.

It should be noted that in the embodiment, the display screen 2 is arranged on a same side as the input module, and the transaction confirmation information is displayed on the display screen 2, so that the user, in the process from entering a password to confirming a transaction, can always pay attention to the IC card, thereby effectively preventing others from spying on the password.

### Sixteenth Embodiment

An IC card with a password input system is provided according to the sixteenth embodiment of the present disclosure. The sixteenth embodiment is a further improvement of the fifth embodiment to the fifteenth embodiment. The main improvement is that the third password stored at the cloud end is replaced by a one-way hash value of the third password.

In the step in which the IC card sends the first password to the cloud end and the cloud end updates the stored third password based on the first password, the IC card calculates a one-way hash value of the first password and sends the one-way hash value of the first password to the cloud end, and then the cloud end updates a one-way hash value of the stored third password based on the one-way hash value of the first password.

The third password stored at the cloud end is the one-way hash value of the third password, thus it is only required to compare the one-way hash value of the first password with the one-way hash value of the third password to perform password authentication, thereby achieving high security.

Thus, the first password and the third password are not to be recorded in the cloud end. Even if data is stolen, the password is not to be disclosed.

It should be noted that the one-way hash value in the embodiment may be an MD5 code, an SHA-256 code, and the like.

In the embodiment, the comparison between the first password and the third password may be performed by comparing a hash value of the first password and a hash value of the third password, or comparing a feature value of the first password and a feature value of the third password. After the password authentication is performed successfully, a payment terminal forwards communication content between the IC card and the cloud end. The communication content may be related to the payment process, so that the payment action can be performed through the IC card.

In the embodiment, a signature of the first password by a first private key is replaced by a signature of the hash value of the first password by the first private key.

In the embodiment, a signed hash value of the first password is transmitted and stored, further reducing the risk of the first password being disclosed in transmission.

### Seventeenth Embodiment

An IC card with a password input system is provided according to the seventeenth embodiment of the present disclosure. The seventeenth embodiment is a further improvement of the fifth embodiment to the sixteenth embodiment. The main improvement is that in the seventeenth embodiment of the present disclosure, the fourth password stored at the cloud end is replaced by a one-way hash value of the fourth password.

In the step in which the APP sends the second password to the cloud end and the cloud end updates the stored fourth password based on the second password, the APP calculates a one-way hash value of the second password and sends the one-way hash value of the second password to the cloud end, and then the cloud end updates a one-way hash value of the stored fourth password based on the one-way hash value of the second password.

The one-way hash value of the second password may be calculated by the cloud end, or may be calculated by a mobile terminal.

In the step in which the mobile terminal sends the second password to the cloud end and the cloud end updates the stored fourth password based on the second password, the mobile terminal calculates a one-way hash value of the second password and sends the one-way hash value of the second password to the cloud end, and then the cloud end updates a one-way hash value of the stored fourth password based on the one-way hash value of the received second password.

Thus, the mobile terminal does not record the second password, and the second password does not appear in a communication channel between the mobile terminal and the cloud end, effectively reducing the risk of the second password being stolen.

According to the embodiments of the present disclosure, the one-way hash value of the first password may be calculated by the cloud end or by the processor module of the IC card.

Specifically, in the step in which the processor module of the IC card sends the first password to the cloud end via the communication module of the IC card and the cloud end compares the first password with the third password, the processor module calculates a one-way hash value of the first password and sends the one-way hash value of the first password to the cloud end, and then the cloud end compares the one-way hash value of the first password with the one-way hash value of the third password.

Thus, the one-way hash value of the first password calculated by the processor module is sent to the cloud end via the payment terminal, so that the payment terminal only receives the one-way hash value of the first password, greatly improving the security and effectively reducing the risk of a forged or modified payment terminal stealing the password.

In some embodiments, the processor module obtains transaction confirmation information from a payment device and sends the transaction confirmation information to the display screen 2. The transaction confirmation information is displayed on the display screen 2, so that the user, in the process from entering a password to confirming a transaction, can always pay attention to the IC card, thereby effectively preventing others from spying on the password.

It should be understood by those skilled in the art that in the above embodiments, many technical details are described to enable the readers to understand this application well. However, even without the technical details and various changes and modifications based on the above embodiments, the technical solutions according to the claims of the present disclosure can be almost realized. Therefore, in practical application, various modifications can be performed based on the above embodiments in form and detail without departing from the spirit and scope of the present patent.

What is claimed is:

1. An IC card asymmetric labelling system, comprising:
an IC card, a payment terminal and a cloud end sever; wherein
the IC card comprises a crypto-key unit and a communication module;
the crypto-key unit is configured to generate a pair of private key and public key, the private key is called as the first private key and is used for digitally signing a transaction message transmitted from the IC card, the first private key is stored in a unit and cannot be accessed outside; the public key is called as the first public key and is sent to a cloud end and stored in the cloud end for signature authentication;
the communication module is configured to indirectly establish a communication connection with the cloud end through a payment terminal, or to directly establish a communication connection with the cloud end if the IC card is capable of wide area network (WAN) communication;
an open ID is obtained by performing one or more times of hash calculation on the first public key of the IC card, the open ID is accessible to public and is associated with confidential user information in the cloud end;
during a fund transaction, the payment terminal obtains the open ID from the IC card and inserts the open ID into the transaction message, and digitally signs the open ID and the transaction message and sends the signed open ID and transaction message to the cloud end; the cloud end first determines that the signature authentication is passed, and then finds stored corresponding user information based on the received open ID, and processes the fund transaction by using both the transaction message and the user information.

2. The IC card asymmetric labelling system according to claim 1, wherein the crypto-key unit is further configured to generate another pair of private key and public key, the private key is called as the second private key and is used for digitally decrypting a message transmitted to the IC card, the second private key is securely stored in the crypto-key unit and cannot be accessed outside; the public key is called as the second public key and is sent to the cloud end and stored in the cloud end for computing a ciphertext of the user information associated with the open ID; a plaintext of the user information is deleted and only the ciphertext of the user information is stored in the cloud end to protect privacy;
during the fund transaction, when the cloud end obtains the open ID of the IC card, corresponding ciphertext of the user information is found in the cloud end and sent to the IC card through the payment terminal, and the user information is decrypted by the crypto-key unit; then the plaintext of the user information is send back to the cloud end and is used to complete the fund transaction; finally, the plaintext of the user information is deleted from the cloud end.

3. The IC card asymmetric labelling system according to claim 1, wherein the crypto-key unit is further configured to store a cloud end public key, wherein a pair of cloud end private key and cloud end public key are generated in the cloud end, and the cloud end private key is always stayed in the cloud end, the cloud end public key is sent to the IC card and stored in he IC card; the user information associated with the open ID is no longer stored in the cloud end, and is stored locally or in a distributed manner, in the IC card after being encrypted with the cloud end public key;
during a transaction, a ciphertext of the user information in the IC card is sent back to the cloud end possibly through the payment terminal, and the ciphertext is decrypted with the cloud end private key to obtain a plaintext in the cloud end, then the fund transaction is completed based on the user information; finally, the plaintext of the user information is deleted from the cloud end to prevent hacking.

4. The IC card asymmetric labelling system according to claim 2, wherein the cloud end also stores a hash value of the user information; during the fund transaction, the temporary plaintext of the user information, which is obtained from decryption by the second private key or the cloud end private key, is compared with the hash value to ensure that the data is not altered.

5. The IC card asymmetric labelling system according to claim 2, wherein the crypto-key unit of the IC card decrypts the ciphertext of the user information by using the second private key; before the plaintext is sent out from the IC card, the plaintext is first encrypted by the cloud public key, and then, the ciphertext is sent indirectly or directly to the cloud end; when the ciphertext reaches the cloud end, it is first decrypted with the cloud private key and then is used for processing the fund transaction; finally, the plaintext of described user information is deleted.

6. A password input system for a password-inputtable IC card in the IC card asymmetric labelling system according to claim 1, wherein
the IC card is provided with an input module for inputting a first password; when the first password is inputted to the input module, a digital signature of the first password is calculated by the crypto-key unit with the first private key, then both the first password and the signature of the first password are sent to the cloud end; the cloud end first authenticates the digital signature by the first public key, and then compares the first password with a third password stored in the cloud end; if both signature authentication and password authentication are passed, the cloud end processes a transaction message forwarded by the payment terminal and complete the fund transaction; if at least one of the signature authentication and the password authentication is failed, the cloud end terminates the transaction process.

7. The password input system for a password-inputtable IC card according to claim 6, further comprising an APP connecting with the cloud end through a mobile terminal; the APP is operable if a second password inputted to the APP matches with a fourth password stored in the cloud end or if the APP is in a password initialization mode or a password resetting mode.

8. The password input system for a password-inputtable IC card according to claim 7, wherein the APP of the mobile terminal, with support of the cloud end, performs the password initialization mode in following ways:
i) establishing a communication connection between the IC card and the mobile terminal, and authenticating whether the IC card is a new card based on the open ID of the IC card in the cloud end; in a case that the IC card is not a new card, exiting the password initialization mode and jumping to the password resetting mode;
ii) entering new user information, and determining whether the entered user information is indeed new through the cloud end; if the entered user information is not new, exiting the password initialization mode;
iii) entering following authentication information:
a) a mobile phone number and/or an email address;
b) a background information quiz;
c) a biological authentication feature;
iv) under a system prompter, entering the first password into the APP, re-entering the same first password on the IC card; this process is repeated if necessary until the entries on the two devices are identical; then, the first password is transmitted to the cloud end by the APP, and is stored in the cloud end as the third password; and
v) under a system prompter, entering the same second password twice on the APP of the mobile terminal; the second password is for running the APP; then, the second password is sent to the cloud end by the APP and is stored in the cloud end as the fourth password.

9. The password input system for a password-inputtable IC card according to claim 8, wherein the APP of the mobile terminal, with support of the cloud end, performs the password resetting mode on the first password in following ways:
i) establishing a communication connection from the IC card to the mobile terminal, and then to the cloud end; searching for corresponding user information based on the open ID of IC Card, and confirming the user information by the user;
ii) authenticating at least one of items a), b) and c) defined in step iii), or authenticating at least two of items a), b) and c);
iii) under a system prompter, entering a new first password on the APP of the mobile terminal, and then entering the same first password on the IC card according to the prompter, and repeating the operation until the entries on the two devices are identical; then, sending the first password from the APP to the cloud end and store the first password as the third password.

10. The password input system for a password-inputtable IC card according to claim 8, wherein the APP of the mobile terminal, with support of the cloud end, performs the password resetting mode on the second password in following ways:
i) establishing a communication connection from the IC card to the mobile terminal, and then to the cloud end; searching for corresponding user information based on the open ID of IC Card, and confirming the user information by the user;
ii) authenticating at least one of items a), b) and c) defined in step iii), or authenticating at least two of items a), b) and c);
iii) under a system prompter, continuously entering the second password twice, repeating the operation if necessary, until the last two entries are identical; then sending the second password to the cloud end, and store the second password as the fourth password in the cloud end.

11. The password input system for a password-inputtable IC card according to claim 8, wherein the APP of the mobile terminal, with support of the cloud end, has a password modification function; after selecting a function of modifying the first password for IC card on the APP, the system prompts the user to enter an original first password, after the system determines that the original first password is correct, a new first password is entered; then the system prompts the user to input the same first password on the IC card and repeat the operation until the entries on the APP and the IC card are identical; then the crypto-key unit of the IC card calculates the signature of the new first password by the first private key, finally, the APP send both the new first password and its signature to the cloud end, and the third password is updated after the signature is authenticated in the cloud; and
after selecting a function of modifying the second password of the APP, the system prompts the user to enter an original second password, after the system determines that the original second password is correct, a same new second password is entered twice; repeating the operation, until the last two entries are identical; then, the new second password is sent to the cloud end by the APP, and stored in the cloud as a new fourth password.

12. The password input system for a password-inputtable IC card according to claim 6, wherein the input module comprises N touch pads or keys formed as an array, or a touch screen on a surface of the IC card, where N is a natural number greater than or equal to 4, a sequence of touching or pressing these points is used as the first password; the signature of the recorded sequence by the first private key is the signature of the first password.

13. The password input system for a password-inputtable IC card according to claim 6, wherein N is equal to 9, a nine-square grid is formed on the surface of the IC card, to form a pattern locker be inputted to a device, with the pattern locker as the first password.

14. The password input system for a password-inputtable IC card according to claim 6, wherein the IC card is further provided with a battery for supplying power to the crypto-key unit, the input module and the communication module.

15. The password input system for a password-inputtable IC card according to claim 6, wherein the IC card is further provided with a solar charging panel or a solar charging film for charging the battery.

16. The password input system for a password-inputtable IC card according to claim 7, wherein the third password stored in the cloud end is replaced by the one-way hash value of the third password, during a process of password update, the IC card calculates the one-way hash value of the first password, which is sent it to the cloud end and to replace the historic third password hash value; during a transaction, the first password inputted on the IC card is sent to the cloud end, is made a hash-comparison against the hash value of the third password, and the signature of the first password by the first private key is replaced by the signature of the hash value of the first password by the first private key.

17. The password input system for a password-inputtable IC card according to claim 7, wherein the fourth password stored in the cloud end is replaced by the one-way hash value of the fourth password; during the process of password update, the APP on the mobile terminal calculates the one-way hash value of the second password, which is sent to the cloud end and to replace the historic third password hash value; to start the APP, the second password inputted on the APP of the mobile terminal is sent to the cloud end, and is made a hash-comparison against the hash value of the fourth password.
